(19) United States
(12) Patent Application Publication
(10) Pub. No.: US 2011/0266334 A1
(43) Pub. Date: Nov. 3, 2011

(54) Single-handed operable packaging

(75) Inventor: Jan-Niklas Keltsch, Bad Schwartau (DE)

(73) Assignee: Jan-Niklas Keltsch, Bad Schwartau (DE)

(21) Appl. No.: 13/098,808

(22) Filed: May 2, 2011

(30) Foreign Application Priority Data
May 2, 2010 (DE) 102010019161.2-27

(51) Int. Cl. B65D 27/12; B31B 19/00

(52) U.S. Cl. 229/76; 493/186; 493/213; 493/245

(57) ABSTRACT

The invention relates to a packaging with a packaging closure and a method for producing such a packaging.

To provide a particularly easy to-use packaging, the packaging according to the invention comprises: a first side panel and a second side panel, said first and second side panel forming an opening of an interior of the packaging for receiving a product, and wherein the first side panel comprises a flap, and a coupling element, wherein the flap comprises a pulling area and a separation area, wherein said separation area is configured to be located in the opening, wherein the pulling area is configured to pull the separation area from the opening, and wherein the coupling element is configured to couple the separation area to the first and/or second side panel and to close the opening.

This application claims priority under 35 U.S.C. 119 to German Patent Application No. 10 2010 019 161.2-27 filed 2 May 2010, the entire disclosure of which is herein expressly incorporated by reference.

The invention relates to a packaging and a method for producing a packaging. Packaging with different closing mechanisms is known. Such mechanisms may be Velcro closures, zippers, and clip closures, adhesive closures etc. The packaging may be configured for different applications: for use with food (especially in the kitchen), in industry for packaging of products, in the medical field for sterile packaging etc. An object of the present invention is to provide an easy-to-use packaging for a variety of applications. In accordance with an aspect of the invention, the problem is solved by a packaging for receiving a product, comprising: a first side panel and a second side panel, wherein said first and second side panel form an opening of an interior of the packaging for receiving the product and wherein the first side panel has a flap, and a coupling element, wherein the flap comprises a pulling area and a separation area, wherein said separation area is configured to be placed in the opening, and wherein the pulling area is configured to pull the separation area from the opening, and wherein the coupling element is configured to couple the separation area with the first and/or second side panel, or to couple the first and second side panel to each other, and wherein the coupling element is configured to close the opening, wherein the first and/or the second side panel includes a spreading element for spreading the opening, and wherein the pulling area includes a recess for receiving a finger. The invention is based on the idea of providing a closure for packaging, which allows one-handed operation of the packaging. In accordance with the invention, the packaging is configured to be opened and closed with one hand. In particular, the invention is based on the finding that an one-handed operation is advantageously obtained by clearing the opening for receiving the product by pulling the pulling area substantially opposite the direction in which the product is received through the opening into the interior. In accordance with the invention, the pulling area is configured such that the separation area releases the opening when pulling the pulling area so that the product may be introduced into the interior. The coupling element according to the invention advantageously achieves adhering the separation area with the first side panel and/or second side panel before using the packaging in accordance with the invention, so that the coupling element does not obstruct when storing or beginning to use the packaging and enables closing the opening adhesively after the intended use of the packaging.

A packing closure according to the invention may thus be operated with one hand; that means to be opened or closed.

Thus, a simple operation of a packaging with a packaging closure in accordance with the invention is possible.

Of course, it is also possible to use the packaging with several hands or robot gripper arms or the like.

By the term “product” any element is meant that is to be introduced into the packaging.

This may, for example, be an industrial product, a food product, waste, a material or cell sample, but also any other body that is to be packaged and if necessary removed from the packaging at a later stage.

The packaging in accordance with the invention is preferably used as follows: The user's hand holds the packaging in accordance with the invention with his thumb and middle finger on the side regions of the opening.

The index finger pulls on the pulling area, which in turn pulls the separation area from the opening.

By pulling out the separation area preferably an adhesive coupling between the separation area, the first and/or second side panel is released.

The packaging is now open and the product may be introduced.

To close the packaging the index finger leads the flap over the opening and pushes the separation area, the first and/or second side panels to one another, so that they preferably adhere to each other and close the opening.

In this way, preferably the packaging may be opened and closed one-handed.

The second hand is advantageously without any role in the operation of packaging and may simply and easily introduces the product into the packaging.

According to the invention, the coupling element is preferably configured, to close the packaging in the initial state (separation area is arranged in the opening and between the first and second side panel).

In the initial state the separation area is preferably detachably connected to the first and/or second side panel by means of the coupling element.

According to the invention, the coupling element closes the packaging in the final state (separation area is placed over the opening and closes it).

In particular, the coupling element may also comprise two or more coupling sub-elements, which provide the functions of the preferably detachably coupling of the separation area with the first and/or second side panel in the initial state and closing of the opening in the final state.

The separation area is configured to be positioned in the opening between the first and second side panel in the initial stage.

In the state of the opened packaging, the separation area is located outside of the opening and serves preferably as an insertion support for the product in the opening: the product may slide into the opening on the separation area.

In the final state the separation area is placed over the opening and covers or closes it.

More preferably, the coupling element is located on the first side panel to adherently close the packaging in the final stage.

Advantageously, the separation area separates the interior of the closed packaging (initial state) from the surrounding environment, so that the interior is protected from the elements and contamination of the environment.

The pulling area is located outside the opening in the initial state.

The pulling area is preferably arranged essentially parallel to the insertion direction of the product into the interior of the packaging.

Thus, it is advantageously achieved that by pulling the pulling area the packaging is opened by removing the preferably adhesive bond of the coupling element within the opening.

The pulling area is configured to be pulled against the insertion direction of the product in the interior of the packaging in order to release the preferably adhesive bond of the coupling element in its initial state.

In the state of the opened packaging, the pulling area supports a simple, safe and clean insertion of the product as it preferably stretches the separation area between itself and the first side panel and preferably serves as the third fixed point for holding the packaging (first and second fixed point are the side areas of the opening, where it is preferably held).

The pulling zone is also configured to place the separation area over the opening of the packaging after the introduction of the product in the interior of the packaging and covers up or overlaps it.

According to the invention, the coupling element is used in this final stage for closure of the packaging and the pulling area is preferably configured to enable this packing closing adhesive bond between the coupling element and the second side panel, by pressing or placing the separation area with the help of the pulling area onto the second side panel.

The invention provides a packaging seal for a packaging, which may be operated very simply.

Particularly preferred and advantageous is the operation done by one hand.

Simply pulling on the flap or at its pulling area advantageously does opening the packaging.

The introduction of the product is very simple and clean, as the separation area may serve as a kind of “slide” for inserting the product into the interior.

The closing is also particularly easy by placing the separation area over the opening by “pulling” the separation area by means of the pulling area over the opening.

A packaging with a packaging closure in accordance to the invention is particularly suitable to be used in the following exemplary areas: medical laboratories, forensics, pathology, personal hygiene and other applications where a one-handed opening and closing a packaging is advantageous.

In the area of application of forensic laboratories and pathology collection of samples is often performed manually.

For this purpose, instruments are used that are operated with at least one hand.

These instruments, for example, include tweezers, scrapers, cutting tools and the like.

A sample which has been taken up with such an instrument is intended for being packed in many applications.

Packaging that may be opened and closed with one-hand offers the advantage that the operator does not need to put down neither the sample nor the instrument to prepare the packaging for the insertion.

The invention enables a packaging without preparatory measures to be put in the state for immediate insertion of a sample or the like, and to close it then.

In the application field of personal hygiene, the invention provides a simple and clean solution for receiving a menstrual protection (e.g. tampons, pads, etc.) or non-menstrual panty liners.

The disposal of such is often via the sewer system or the trash without sanitary bags provided for this purpose.

The known hygiene bags have the disadvantage that the application must be prepared so far as the hygiene bags are kept open.

The feeding of the menstrual protection is done with one hand.

The other hand is often not enough to keep open the menstrual bag, which may lead to unwanted misplacement.

The invention offers an advantage in so far that the operator has to make no preparations for opening a packaging and the packaging is in the open state at the desired time.

The industrial sector also offers advantages in the one-handed operation of packaging products (such as precision engineering products, which are packed by hand).

As mentioned above, the invention may be used in a variety of applications and is beneficial and not limited to the examples described herein.

In particular, it is not necessary that the packaging closure according to the invention is operated with one hand, but an operation by a machine or different, in particular mechanical device is also possible.

In a preferred embodiment, the coupling element is an adhesive element.

Preferably, the coupling element comprises a chemical component that is activated when the separation area is removed from the opening, i.e. when the packaging according to the invention is activated.

Such a configuration has the advantage that the coupling element develops a particularly strong adhesive effect when the packaging is activated and then closed. Preferably, the coupling element is an adhesive element, which is configured at the initial state to detachably adhere the separation area and the first side to each other. A particularly preferred coupling element, in particular an adhesive element, placed at the first side panel is configured to couple the first and second side panel to each other at the final state.

Such a design offers the advantage that by pulling out the separation area it is unrolled from the coupling element.

There is thus a very simple release of the adhesive bond between separation area and the first side panel.

In an arrangement of the coupling element at the first side panel it is therefore advantageous that the separation area may be by drawn off successively from the coupling element by pulling on the pulling area (a similar advantage may be achieved when the coupling element is arranged on the separation area and detachably adhered to the first side panel).

It is also advantageous that the coupling element placed on first side panel may produce a connection to the second side panel, so as to close the packaging after the introduction of the product.

In another preferred embodiment, the coupling element is a Velcro closure.

This closure has the property that is produces a mechanical connection with an area like that of a Velcro fastener and so links both sides to each other.

Preferably, the coupling element is configured such that an coupling is achieved only when two parts of the coupling element are brought together (in the manner of a Velcro fastener).

This may prevent that the coupling element is accidentally connected to a non-desired area or impractical area for the use of the packaging.

In another preferred embodiment, the coupling element is a mechanical connection (such as a so-called zip-lock).

This provides similar benefits as described Velcro.

By the term “coupling element” all such coupling mechanisms are meant that may affect the functions, described in the present application, of the connection of the separation area with the first and/or second side panel and closing the opening.

In alternative or additional embodiments, it is preferred that the coupling element is placed on the first side panel, second side panel and/or the separation area.

Thus, for example, a closing of the interior between the first side panel with the second side part is advantageously achieved via the tab.

It is also preferred that the coupling part elements are arranged on the first, second side panel and/or on the separation area.

Preferably the first and/or second side comprises a spreading element for spreading the opening.

An advantage of this embodiment is that the opening to the interior is spread by the spreading element, whereby it is further advantageously facilitated for the user to place the product in the packaging.

In accordance with the invention, the spreading is achieved by applying force to the spreading element.

The force is preferably applied by holding the packaging at the side regions of the opening as already explained, whereby the one-handed operation is further simplified.

By holding the packaging it is preferably put in readiness for activation.

When the user wants to open the packaging for introducing the product, he pulls—as already explained—the separation area out of the opening.

In the preferred embodiment with a spreading element, the user applies force to the spreading element; thereby the opening of the packaging is supported.

The removal of the separation area is advantageously facilitated by the spreading element, which supports the release of (“de-stick”) of the coupling between separation area and preferably the first side panel since the spreading element preferably deflects the first side panel from the opening to the outside.

The first side panel forms an arc by means of the spreading element when applying appropriate force, which advantageously increases the opening area, so that the introduction of the product is further simplified.

Furthermore, the advantage is achieved that the deflection of the first side panel by means of the spreading element may affect the shape of the flap, so that in a preferred embodiment, the flap is curved, as long as the spreading element is activated (i.e., under force).

The arc-shaped flap is used advantageously as a “slide” for the product introduced in the packaging.

A similar configuration of the second side panel in addition to or instead of that of the first side part with a spreading element is also preferred.

In a preferred embodiment, the spreading element is a particular elastic rod.

With “rod” a body is identified, which is formed rather long in proportion to its cross-diameter.

The rod preferably has a circular cross section.

In another preferred embodiment, the coupling element includes the spreading element.

The coupling element preferably has a separate spreading element (especially the rods).

It is also preferred that the coupling element itself assumes the function of the spreading element, wherein the coupling element is an adhesive strip that is configured to spread the opening. This may be an advantage in producing the product as the combination of coupling and spreading element may be applied to the product in a single step. This step preferably follows the step of folding the separation area. The distinction between two production steps may alleviate folding the separation area.

In a preferred embodiment, the first side panel and/or the second side panel is the spreading element for spreading the opening.

The longitudinal axis of the spreading element is preferably oriented parallel to the opening area.

Preferably, the first and/or second side panel is reinforced in the region of the opening so that this region acts as a spreading element.

In a preferred embodiment, the spreading element is configured to be bend under the force along its longitudinal axis, in particular bent perpendicular with respect to its longitudinal axis.

Preferably, the spreading element is configured to absorb the force along the longitudinal axis and to bend under this force, and in particular bend in the direction perpendicular to the longitudinal axis.

In a preferred embodiment, the spreading element is configured to release the connection of the separation area with the first and/or second side panel when force is applied along its longitudinal axis.

Preferably, the spreading element supports the release by its deflection in the opposite direction to the opening.

In a preferred embodiment, the spreading element is configured to enable pulling the separation area from the opening when a force along its longitudinal axis is applied. More preferably, the spreading element is configured to support pulling the separation area from the opening if a force is applied along its longitudinal axis.

In a preferred embodiment, the pulling area includes a gripping surface and/or a recess.

Preferably, the recess is designed to accommodate a finger.

This has the advantage that for example the index finger may be inserted into the recess to pull the separation area from the opening.

Preferably, the recess is configured to accommodate a human finger.

It may also be preferred that the recess is adapted to a mechanical device to cause opening the packaging by pulling out the separation area.

The grip is preferably designed to accommodate at least one human finger so that the separation area may be pulled out of the opening by moving the finger.

In a preferred embodiment, the separation area is located on the first side panel and the pulling area is located at the separation area.

Preferably, the flap is arranged on the first side panel, wherein the separation area is located at the region near the side of the flap and the pulling area in the remote area of the flap.

Preferably, the flap and the first side panel are integrally formed, whereby a particularly simple manufacturing of the packaging is achieved.

In a preferred embodiment, the flap comprises a first and a second fold, wherein said first fold is positioned between the first side panel and the separation area and the second fold is placed in the separation area.

Preferably, the flap comprises a first fold and a second fold, wherein the first fold is arranged between the first side panel and a first part of the separation area and the second fold is arranged between the first part of the separation area and a second part of the separation area.

Folds have the advantage that the packaging may be formed particularly flat, which is advantageous for the transport and storage.

The first and/or second side panels are preferably made of plastic.

Preferably, the first and/or second side panels are made of paper.

Mixed forms of the aforementioned materials are preferred as well.

The spreading element is preferably made of plastic or metal.

Depending on the application of the packaging according to the invention, the side panels, coupling element, flap, and/or spreading element may also be designed from other material known by the skilled person for this purpose.

In another aspect, the invention relates to a packaging closure of a packaging in accordance with the invention.

In the scope of the invention, it is included that packaging may be refitted with a packaging closure in accordance with the invention.

Such a packaging closure according to the invention includes at least the flap with the pulling area and separation area and the coupling element, such as described herein with reference to the packaging.

In another aspect, the invention relates to a method of manufacturing a packaging according to the invention, comprising the steps of: providing a first side panel and a second side panel to form an interior and an opening of the interior of the packaging for receiving the product, providing a spreading element for spreading the opening on the first and/or second side panel, providing a flap on the first side, wherein said flap comprises a separation area and a pulling area, providing a recess in the pulling area for receiving a finger, providing a coupling element for closing the opening, wherein the coupling element is configured to couple the separation area with the first and/or second side panel, or to couple the first and second side panel to each other, placing the separation area in the opening, placing the pulling area outside the opening for enabling pulling the separation area from the opening.

A preferred method for manufacturing a packaging provides the folding of the separation area. A further preferred method for manufacturing a packaging provides that the spreading element and/or coupling element is connected to the first and/or second side panel and thereby at least partially covers the area of the folding of the separation area. This ensures that the activity of folding the separation element is not impeded by the opening, which is preferably produced in the subsequent manufacturing step, which provides the application of the coupling element and/or spreading element on the first and/or second side panel. It is ensures that the separation area, as intended, is located within the opening of the packaging, because the spreading element and/or the coupling element, at least in part, covers the region of the folding of the separation area.

Alternatively to the above-described embodiments, it is also preferred that the separation area is arranged outside the opening.

In such an embodiment, the concept according to the invention of the one-handed operation is implemented a similar manner as previously arranged, with the difference that the separation area (described below as the first and second part of the separation areas) is located outside the opening on the outside of the second side panel and is detachably connected thereto by means of the coupling element. The coupling element is therefore arranged to the outside of the second side panel and/or the separation area.

By pulling the pulling area, the coupling between the outside of the second side panel and the separation area is disconnected and the opening is cleared to receive the product.

After introducing the product into the interior, the separation area is passed over the opening and the separation area and the outside of the second side part is connected by means of the coupling element.

Although preferred embodiments relate to the coupling element being configured to detachably adhere the first side panel, second side panel and/or separation area in the initial state to each other, the present invention also encompasses preferred embodiments in which the coupling element is arranged between the first side panel, second side panel and/or separation area without any coupling or adhering function in the initial state.

Preferably, the coupling element is configured to close the opening by coupling the separation area with the first and/or second side panel, or by coupling the first and second side panel to each other.

In a preferred embodiment, the coupling element is a zip-seal, grip-seal or clip-seal or the like (similar to those applied for freezer bags) and is configured to rest against the first side panel, second side panel and/or separation area and to close the opening by coupling the separation area with the second side panel, or by coupling the first and second side panel to each other.

Below, preferred embodiments of the closure of the packaging in accordance with the invention are exemplary described with reference to figures, wherein

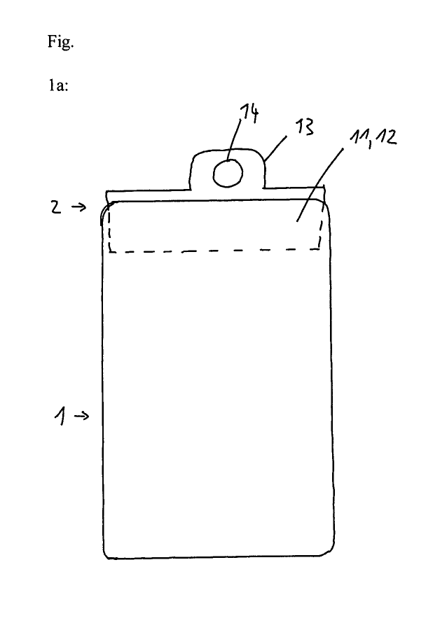

FIG. 1a shows a preferred embodiment of a packaging in accordance with the invention in the initial state as top view;

FIG. 1b shows a preferred embodiment of the packaging in accordance with the invention of FIG. 1a in the initial state in longitudinal section;

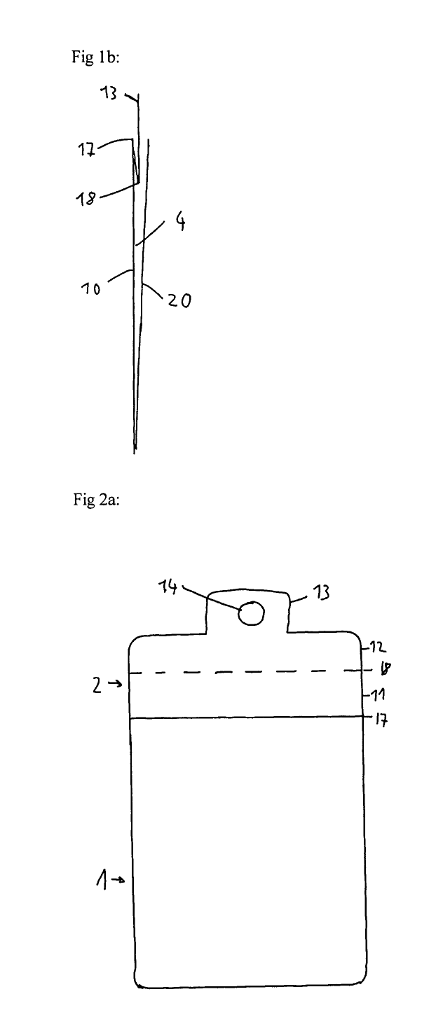

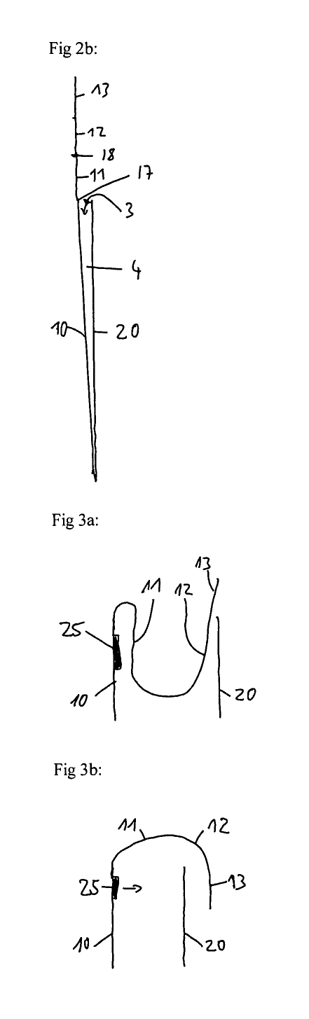

FIG. 2a shows a preferred embodiment of the packaging in accordance with the invention of FIG. 1a in the open state as top view;

FIG. 2b shows a preferred embodiment of the packaging in accordance with the invention of FIG. 1a in the open state in a longitudinal section;

FIG. 3a shows a detailed view of a first preferred embodiment of a coupling element arrangement in the initial state according to the invention;

FIG. 3b shows a detailed view of the first preferred embodiment of a coupling element arrangement in the final state according to the invention;

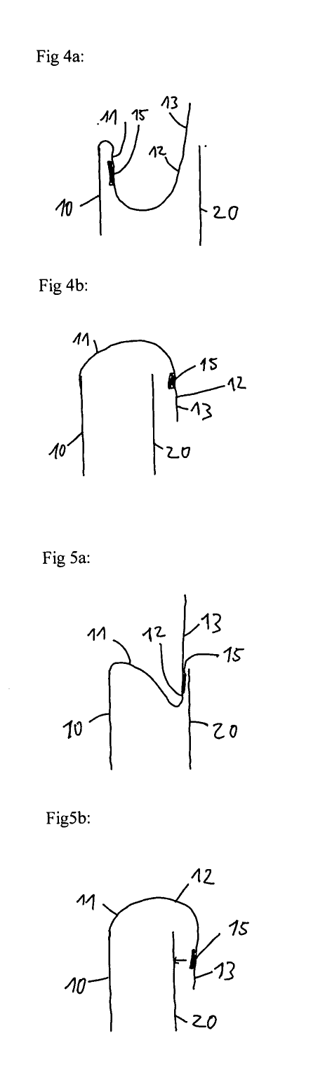

FIG. 4a shows a detailed view of a second preferred embodiment of a coupling element arrangement in the initial state according to the invention;

FIG. 4b shows a detailed view of the second preferred embodiment of a coupling element arrangement in the final state according to the invention;

FIG. 5a shows a detailed view of a third preferred embodiment of a coupling element arrangement in the initial state according to the invention;

FIG. 5b shows a detailed view of the third preferred embodiment of a coupling element arrangement in the final state according to the invention;

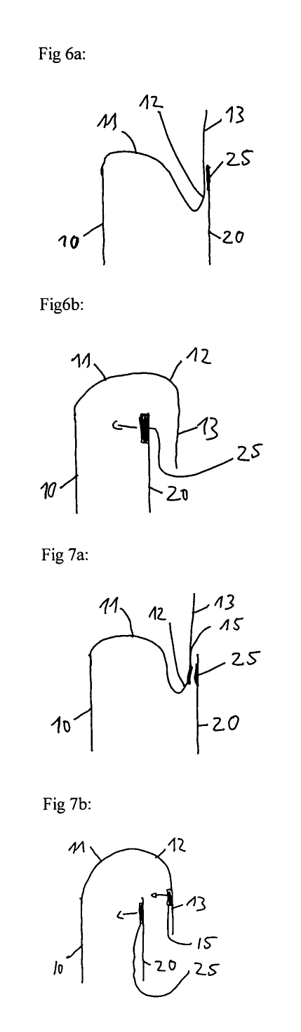

FIG. 6a shows a detailed view of a fourth preferred embodiment of a coupling element arrangement in the initial state according to the invention;

FIG. 6b shows a detailed view of the fourth preferred embodiment of a coupling element arrangement in the final state according to the invention;

FIG. 7a shows a detailed view of a fifth preferred embodiment of a coupling element arrangement in the initial state according to the invention;

FIG. 7b shows a detailed view of the fifth preferred embodiment of a coupling element arrangement in the final state according to the invention;

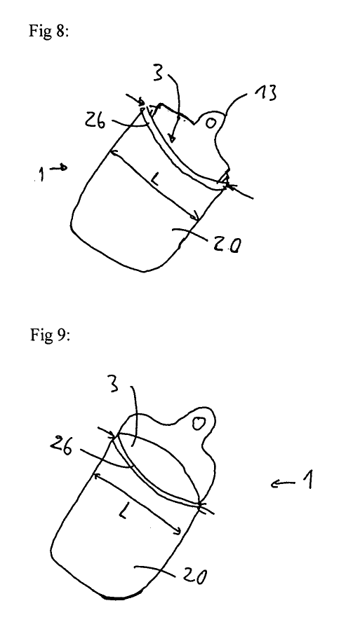

FIG. 8 shows an embodiment of a packaging in accordance with the invention with spreading element shown in the initial state;

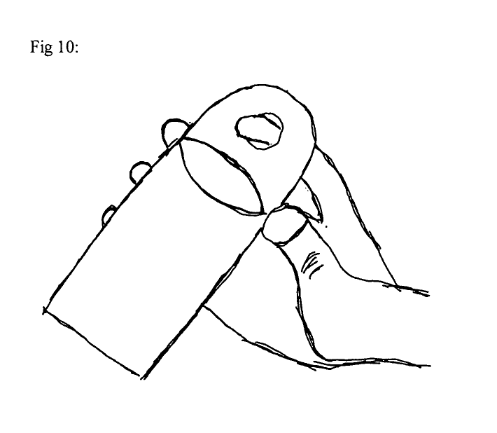

FIG. 9 shows the embodiment of FIG. 8 in the open state;

FIG. 10 illustrates how the packaging in accordance with the invention may be operated with one hand.

FIG. 1a shows a packaging in accordance with the invention 1 with a packaging closure 2 in accordance with the invention.

The packaging has a flap, which includes the separation area 11, 12 and the pulling area 13.

The pulling area 13 has a recess 14 in which a human finger may be introduced, as shown in FIG. 10.

The separation area 11, 12 has a first part 11 and a second part 12 which are arranged in the initial state shown in FIG. 1a in the opening of the packaging 1, as illustrated in FIG. 1b.

A folding 17 is provided between the first part 11 and the first side part 10.

Between the first and the second part of the separation area 11, 12, a second fold 18 is provided.

Depending on the chosen material for the side parts 10, 20 and the flap 11, 12, 13 a bent edge, bending or the like may be provided instead of a folding 17 (and 18).

The packaging 3 has a first side panel 10 and a second side panel 20, which form the interior 4 of the packaging 3 between them.

In the FIGS. 1a and 1b is shown that the puling zone 13 and the recess 14 are arranged outside the opening of the packaging.

In FIGS. 2a and 2b is shown how the packaging in accordance with the invention of FIGS. 1a and 1b looks like when the separation area 11, 12 was removed by pulling the pulling area 13 from the opening.

3a to 7b illustrate some preferred embodiments of an arrangement of the coupling element 15, 25 on the first side panel 10, the second side panel 20 and/or the separation area 11, 12.

FIG. 3a shows the first side part 10, the second side part 20 and the separation area 11, 12 arranged in the opening between the first and second side panel 10, 20 in the initial state.

The first side section 10 has a coupling element 25, which is rests against the first part 11 of the separation area and is releasably bonded to it.

If the separation area 11, 12 is removed from the opening between the first and second side panel 10, 20 by pulling the pulling area 13, the first part 11 gradually rolls off from the bonding element 25.

This makes it very simple to open the packaging 1.

If the product is introduced into the packaging 1, the packaging 1 is closed, as shown in FIG. 3b (final state).

The first and second parts 11, 12 of the separation area is placed or pulled over the opening of the packaging.

The coupling element 25 may now take over the function of closing the packaging 1 by bonding the first side 10 to the second side section 20, as indicated in FIG. 3b by the arrow.

In FIGS. 4a and 4b shows an embodiment where the coupling element 15 is located on the first part 11.

Similar benefits, as explained with reference to FIGS. 3a and 3b may be achieved, with the difference that a closure of the packaging is on the outer surface of the packaging (between the first part 11 and the second side panel 20) in the final state. In the embodiment of FIGS. 5a and 5b, the coupling element 15 is located on the second part 12.

The embodiment of FIGS. 6a and 6b provides the coupling element 25 on the second side part 20.

In the embodiment of FIGS. 7a and 7b two coupling sub-elements are used 15 and 25.

The embodiments of FIGS. 5a to 7b have in common that the interior 4 of the packaging is closed in the initial state.

FIGS. 8 and 9 show an embodiment with a spreading element 26.

The packaging 1 of the FIGS. 8 and 9 has a spreading element 26 which is provided on the second side part 20.

The arrows illustrate the force along the longitudinal axis L when the packaging 1 is held at the two side portions of the opening 3, as illustrated in FIG. 10.

Thumb and middle finger pressing the side regions of the opening 3 and apply a force along the longitudinal axis L to the spreading element 26.

This causes the spreading element 26 to be deflected, pulling the separation area 11, 12 by means of the pulling zone 13 is supported and the opening 3 is spread open.

If the separation area 11, 12 is drawn from the opening 3, as shown in FIG. 9, the product may be inserted through the opening 3 into the interior 4.

1. Packaging for receiving a product comprising
a first side panel and a second side panel, wherein the first and the second side panel form an opening of an interior of the packaging for receiving the product, and wherein the first side panel comprises a flap, and
a coupling element,
wherein the flap comprises a pulling area and a separation area, wherein said separation area is configured to be disposed in the opening, and wherein the pulling area is configured to pull out the separation area from the opening,
wherein the coupling element is configured to
(a) couple the separation area with the first and/or second side panel, or to
(b) couple the first and second side panel to each other
and to close the opening,
wherein the first and/or the second side panel includes a spreading element for spreading the opening, and
wherein the pulling area includes a recess for receiving a finger.

2. Packaging according to claim 1, wherein the coupling element is located on the first side panel, the second side panel and/or the separation area.

3. Packaging according to claim 1, wherein the coupling element is configured to detachably connect the separation area with the first and/or second side panel.

4. Packaging according to claim 1, wherein the first side panel and/or the second side panel is the spreading element for spreading the opening.

5. Packaging according to claim 1, wherein the spreading element is configured to be bend under the force along its longitudinal axis in the direction perpendicular to the longitudinal axis.

6. Packaging according to claim 1, wherein the spreading element is configured to release the connection between the separation area and the first and/or second side panel when force is applied along its longitudinal axis.

7. Packaging according to claim 1, wherein the spreading element is configured to enable pulling the separation area from the opening when force is applied along its longitudinal axis.

8. Packaging according to claim 1, wherein the separation area is located on the first side panel and the pulling area is located on the separation area.

9. Packaging according to claim 1, wherein the coupling element is a Grip-seal

10. Packaging according to claim 1, wherein the spreading element comprises the coupling element.

11. A method of manufacturing a packaging according to claim 1, comprising the steps
providing a first side panel and a second side panel for forming an interior and an opening of the interior of the packaging for receiving the product,
providing a spreading element for spreading the opening on the first and/or second side panel,
providing a flap on the first side panel, wherein the flap comprises a pulling area and a separation area,
providing a recess in the pulling area for receiving a finger,
providing a coupling element for closing the opening, wherein the coupling element is configured to
(a) couple the separation area with the first and/or second side panel, or to
(b) couple the first and second side panel to each other
arranging the separation area inside the opening, and
arranging the pulling area outside the opening for enabling pulling the separation area out from the opening.

12. Method according to claim 11 wherein the step of providing a separation area comprises the folding of the separation area.

13. Method according to claim 11 wherein the step of providing the spreading element and/or the step of providing the coupling element comprises connecting the spreading element and/or coupling element to the first and/or second side panel.
